(19) United States
(12) Patent Application Publication
(10) Pub. No.: US 2022/0186042 A1
(43) Pub. Date: Jun. 16, 2022

(54) Flame Retardant Coating for Textiles

(71) Applicant: Schoeller Textil AG, Sevelen (CH)

(72) Inventor: Vedran Gartmann, Zurich (CH)

(21) Appl. No.: 17/442,960

(22) PCT Filed: Mar. 23, 2020
(86) PCT No.: PCT/EP2020/057920

§ 371 Date: Sep. 24, 2021

(30) Foreign Application Priority Data
Mar. 26, 2019 (CH) CH391/19

(51) Int. Cl. C09D 5/18; C09D 7/61; C09D 7/63; C09D 175/06; C09D 175/08; C09D 133/04; C09K 21/04; C09K 21/10; D06M 11/72; D06M 11/74; D06N 3/00; D06N 3/14

(52) U.S. Cl. CPC C09D 5/185; C09D 7/61; C09D 7/63; C09D 175/06; C09D 175/08; C09D 133/04; D06M 2200/30; C09K 21/10; D06M 11/72; D06M 11/74; D06N 3/0059; D06N 3/14; D06N 3/0063; C09K 21/04

(57) ABSTRACT

Disclosed is a flame retardant coating for a textile sheet product, which contains at least one binder or a binder mixture, expandable graphite particles and additionally at least one chemical flame retardant. The grain size of at least 80%, preferably 100%, of the expandable graphite particles is at most 100 μm.

### CROSS-REFERENCE TO RELATED APPLICATIONS

This application is the United States national phase of International Application No. PCT/EP2020/057920 filed Mar. 23, 2020, and claims priority to Swiss Patent Application No. 00391/19 filed Mar. 26, 2019, the disclosures of each of which are hereby incorporated by reference herein in their entireties.

### TECHNICAL FIELD

The present invention relates to the field of flame retardancy for clothing and, more particularly, to flame retardant coatings for textile clothing.

### PRIOR ART

Fire protective clothing is part of the basic equipment of persons exposed to fire and heat in case of fire or other extreme situations. Optimal fire protective clothing is characterized by protection against various external influences, especially fire and heat. This requires a self-extinguishing behavior (Limiting Oxygen Index LOI>25%), prevention of hole formation, insulation capacity in case of emergency and dimensional stability. At the same time, fire-protective clothing must meet various additional requirements for use, which are not met by classic, inherently flame-retardant fibers. Examples include abrasion resistance, dyeability and UV resistance.

The use of expandable graphite as a flame retardant in various applications is known from the prior art. Expandable graphite, produced by acid treatment of flake graphite, is capable of making a multitude of its own mass of combustible material flame retardant. In case of fire, respectively when exposed to high temperatures, the particles of the expandable graphite expand and increase their volume many times. The intumescent layer formed by the expanded graphite, for example on a textile base, protects this textile base very efficiently, as it prevents oxygen access or flame formation and spread. Due to the lower density of the expanded graphite, it also has a very good thermal insulation effect. Heat can only spread poorly through the intumescent layer, so that the substrate and the underlying fabric of the substrate are efficiently protected.

In the prior art, it is known that the flame retardant effect depends directly on the expandability of the expandable graphite used. In addition, it is known that the expandability directly depends on the size of the expandable graphite particles processed in the textile. The larger the expandable graphite particles used, the higher the expandability and the intumescent layer formed in an emergency.

### SUMMARY OF THE INVENTION

Expandable graphite was originally used as a flame retardant in the construction industry, for example in flame retardant wall cladding. For such rigid applications, the use of large expandable graphite particles, typically in the form of disc-shaped platelets, i.e. flakes, with a grain size and/or diameter of greater than 0.2 up to 4 mm represents a major advantage, as the flame-retardant effect is many times higher compared to expandable graphite with a smaller grain size. However, compared to the construction industry, significant problems and difficulties arise when using expandable graphite in the garment industry. For example, flame retardant textiles are often worn under harsh conditions and are therefore subject to severe mechanical stress. This is further exacerbated by frequent washing of the textiles. The large expandable graphite particles used in the prior art often break, crumble or shatter under such mechanical stress, rapidly reducing the protective effect of the flame retardant textile and thus posing a significant risk to the wearer. This is also a problem if these effects only occur at certain positions, for example the elbow joint, and are therefore only noticed in case of an emergency. Depending on the product, the wrinkling caused by wearing and using the textiles is already sufficient to break the expandable graphite particles.

Another disadvantage of many flame-retardant coatings made from expandable graphite/binder mixtures described in the prior art is that, due to the large grain size of the expandable graphite, often only coating methods can be considered which are disadvantageous for suitability as a textile close to the skin, such as clothing or seating material. One coating method used in the prior art is stencil printing. The generally accepted guideline in this process that the stencil opening must be at least three times the size of the largest particle used to ensure reliable production, directly results in the need for very large stencil openings when using large expandable graphite particles as described above, allowing only very coarse coating. Another problem with stencil printing is that the textile cannot be continuously coated. However, stencil printing does not allow a textile substrate to be continuously coated. Until now, this has not been possible in a simple manner using the processes known in the prior art. In order to be able to use other coating methods at all, for example paste coating by means of a slit doctor blade, pretreatment of the expandable graphite is often necessary in the prior art. For example, various ingredients, such as salts and acids of the expandable graphite, can have a negative effect on the stability of a foam during foam coating, so that these must first be removed. Furthermore, paste coating only delivers very heavy and rigid textile surface products, which have hardly any breathable properties.

Another disadvantage of known flame retardant coatings is the low uniformity of the particle density (particles/cm³), which is due to the overall lower particle density when expandable graphite particles of large grain size are used. Coated textile surfaces with low uniformity exhibit much poorer fire behavior.

It is therefore the general object of the invention to overcome, at least in part, one or more disadvantages of the prior art. In advantageous embodiments of the invention, a flame retardant coating for textile sheet products is provided which is more stable to mechanical stress and thus more durable and yet has a satisfactory flame retardant effect, i.e. meets the requirements of the statutory flame retardant standards.

It is also an object of the invention to provide a method for manufacturing textile sheet products according to the invention.

These objects are solved in a general manner by the subject matter of the independent patent claims. Further advantageous embodiments are apparent from the dependent claims and the description.

In a first aspect, the invention relates to a flame retardant coating for a textile sheet product comprising at least one binder or a binder mixture, expandable graphite particles and additionally at least one chemical flame retardant. The grain size of at least 80%, in particular at least 90%, in particular at least 95%, preferably 100% of the expandable graphite particles is at most 100 μm. The percentages can refer here to mass percent, volume percent, as well as absolute percentages. Preferably, the percentages refer to absolute proportions.

In some embodiments, the expandable graphite particles have a substantially cylindrical shape, i.e., they have a round or elliptical cross-section. In such embodiments, the width corresponds to the diameter and the height of the particles corresponds to the height of the cylinder. The height of such a cylinder is thereby arranged perpendicular to the individual graphite layers. However, other forms of the expandable graphite are also conceivable. For example, the expandable graphite particles may be cube-shaped or spherical, with the width corresponding to the length of a cube edge and the height corresponding to a cube edge arranged transversely to this cube edge, or the height and width corresponding to the diameter of the sphere. In some embodiments, irregularly shaped or platelet-shaped expandable graphite may also be used as the expandable graphite particles.

In the context of the present invention, chemical flame retardants refer to flame retardants that can develop a flame-retardant effect through a chemical reaction. Thus, expandable graphite is not a chemical flame retardant in the context of the present invention. These chemical reactions include, but are not limited to, the elimination of water, ammonia, nitrogen oxides, phosphoric acids, or the elimination of gases that can bind oxygen via radical reactions. Chemical flame retardants include amongst others halogenated compounds, organic and inorganic phosphorus compounds, and metal and metalloid oxides, as well as metal hydroxides. A variety of such chemical flame retardants are known to those skilled in the art. Examples of chemical flame retardants in connection with the present invention include aluminum hydroxide, ammonium sulfate, red phosphorus, antimony trioxide, antimony pentoxide, melamine, urea, polybrominated diphenyl ethers and biphenyls, etc. Such chemical flame retardants are generally placed only on the surface of a material exposed to the flames, since they cannot otherwise interfere with the combustion process. In the present invention, however, the expandable graphite not only acts as a flame retardant, but also, through its expansion, causes chemical flame retardants contained in the coating to be transported to the surface exposed to the flames, as a result of which these flame retardants can optimally develop their flame-retardant effect, even if they are not arranged on the surface but within the textile sheet product. This also prevents the chemical flame retardants from being easily washed out, since they are arranged within the flame retardant coating and not merely on the surface of the textile.

It is understood that the components of the flame retardant coating, in particular the expandable graphite, the at least one binder or the binder mixture and the chemical flame retardant are present mixed in the flame retardant coating. In particular, the components may be uniformly mixed in the flame retardant coating. The use of expandable graphite with a grain size of 100 μm or less, offers several advantages over conventional, larger expandable graphite. In this expandable graphite according to the invention, the width and height of the particles are substantially balanced, in particular more balanced than particles used in the prior art. For example, the expandable graphite particles are substantially cube-shaped and/or spherical. In contrast, the expandable graphite particles used in the prior art are often flat and disc-shaped and thus have an unbalanced height to width ratio. The height to width ratio of the individual particles can be between 50:1 to 1:50, in particular 10:1 and 1:10, especially 5:1 to 1:5, preferably 3:1 to 1:3. Since the large plate-like expandable graphites used in the prior art often have diameters of several 100 μm but a much smaller height, these expandable graphites have an unbalanced width to height ratio. A common problem here is that the coatings obtained from them exhibit irregular elevations. Since appearance and haptics are of high importance in the textile industry, such elevations are undesirable. In addition, the textile surface material is easily damaged or worn out more quickly by these undesirable elevations with sometimes sharp edges due to their exposure. These disadvantages can be avoided by the flame retardant coating according to the invention. It is advantageous that in a flame retardant coating according to the invention at least 80% or more of the expandable graphite has a grain size of 100 μm or less and not only that the average particle diameter is 100 μm. This ensures that the majority of the particles have a uniform grain size of, in particular, less than 100 μm and therefore a uniform coating is obtained without irregular elevations. Another advantage is that the expandable graphite can be distributed much more uniformly in the coating and therefore a uniform flame-retardant effect is also provided. In addition, the expandable graphite used, with a grain size of no more than 100 μm, is significantly more stable against mechanical stress than the coarse expandable graphite used in the prior art. Since the coating also contains at least one chemical flame retardant, a satisfactory flame-retardant effect can still be achieved. Another positive effect of using expandable graphite in which at least 80% of the particles have a grain size of 100 μm or less is that precipitation of the expandable graphite from the paste during manufacture is avoided. Such precipitation is a common problem when using larger expandable graphite particles and requires the use of additives and/or special pretreatments of the expandable graphite. Thus, the flame retardant coating according to the invention can be produced at a much lower cost. Furthermore, the small grain size facilitates foam coating, since the foam stability is essentially not negatively affected.

In further embodiments, the average particle diameter of the expandable graphite particles may additionally be at most 100 μm, in particular at most 75 μm, preferably at most 50 μm. This additionally enhances the beneficial effects described above.

Polyurethanes, polyacrylates or polyvinyl acetates, preferably polyurethanes with a molar mass>700 g/mol, can be used as binders, for example.

In preferred embodiments, the grain size of at least 80%, in particular at least 90%, in particular at least 95%, preferably 100% of the expandable graphite particles is at most 75 μm, preferably at most 50 μm. In this case, the advantageous effect described above is further enhanced. In addition, the use of such fine expandable graphite has the advantage that the flame retardant coating according to the invention can be easily processed, since the risk of breaking, crushing and crumbling of the individual expandable graphite particles is significantly reduced. Furthermore, such coatings can also be applied to a textile substrate by means of foam coating without further pretreatment, without negatively affecting the stability of the foam and without the individual expandable graphite particles breaking during foaming. In addition, the grain sizes of such fine expandable graphite are below the size of textile wrinkles, which inevitably occur during wear. This means that the individual expandable graphite particles do not break during wear, but can easily withstand buckling of the textile, i.e. the formation of wrinkles, without the particles breaking. Thus, the service life of an article of clothing with such a flame-retardant coating is significantly increased.

It is known to the skilled person that the grain size of expandable graphite particles can be determined by means of common sieve analysis.

Normally, it would be expected that a flame retardant coating with expandable graphite, in which at least 80% or more of the particles have a grain size of at most 100 μm, in particular at most 75 μm, preferably at most 50 μm, would have an insufficient or at least significantly poorer flame retardant effect due to the small grain size. Surprisingly, however, the small grain size of the expandable graphite allows efficient transport of the chemical flame retardants to the surface exposed to the flames. The interaction of the chemical flame retardants with the expandable graphite thus results in good flame retardancy being achieved despite the small grain size. This is also due, among other things, to the significantly higher particle density, which is only made possible by the use of expandable graphite with a grain size of at most 100 μm, in particular at most 75 μm, preferably at most 50 μm.

Typically, the width, or in the case of substantially cylindrical or spherical particles, the cylinder and/or sphere diameter, can be a maximum of 75 μm, preferably a maximum of 50 μm.

Typically, the flame retardant coating is used for a textile surface product for fire protective clothing.

In some embodiments, the expansion rate of the expandable graphite particles at 1000° C. is 30 to 80 cm³/g, preferably 40 to 50 cm³/g.

Preferably, the pH of the expandable graphite particles is in the range of 6 to 8.

In further embodiments, the binder or binder mixture has a melting point or softening point of 120 to 200° C., preferably 150 to 200° C. In the context of the present invention, the terms melting point and softening point also include a melting, or softening range, which may be characteristic of a binder mixture, for example. Binders, or binder mixtures, which have such a melting or softening point have been found to be advantageous in ensuring that the binder is soft enough at the expansion temperature of the expandable graphite particles so as not to adversely affect the expansion of the expandable graphite. At the same time, the chemical flame retardant can be efficiently transported to the surface.

In preferred embodiments, the expandable graphite particles only expand above a temperature of 180° C., in particular above 190° C., preferably above 200° C. Together with a binder with a melting or softening point of 120 to 200° C., a particularly good flame-retardant effect can be achieved as the particles do not expand before reaching the softening or melting point.

In further embodiments, the at least one chemical flame retardant is selected from the group consisting of polyammonium phosphates, melamine cyanurates, aluminum hydroxide, magnesium hydroxide, and/or antimony compounds, particularly antimony oxide (Sb₂O₃ or Sb₂O₅). In some preferred embodiments, the flame retardant coating comprises only organic chemical flame retardants, such as polyammonium phosphates and/or melamine cyanurates. Additionally, in such embodiments, inorganic chemical flame retardants may be dispensed with such that the at least one chemical flame retardant consists of an organic chemical flame retardant and thus the flame retardant coating does not comprise any inorganic chemical flame retardants.

In some embodiments, the mass ratio of the expandable graphite particles to the chemical flame retardant is in the range of 10:1 to 1:1, particularly 8:1 to 1:1, preferably 5:1 to 1:1. This optimizes the synergistic effect of the chemical flame retardant and the expandable graphite, since the expandable graphite transports the chemical flame retardant out of the flame retardant coating toward the surface exposed to the flames. If the proportion of the chemical flame retardant is significantly below the proportion of the expandable graphite particles, the flame retardant effect decreases.

In further preferred embodiments, the flame retardant coating contains 20 to 40% by weight of expandable graphite particles, and/or 5 to 15% by weight of chemical flame retardant, and/or 30 to 40% by weight of binder or binder mixture. A relatively high proportion of expandable graphite of 20 to 40 wt. % does not lead to a restriction of the wearing comfort of the textile coated with the flame retardant coating due to the small grain size according to the invention. At the same time, however, a ratio of expandable graphite to binder of up to 1:1, in particular from 1:2 to 1:1, is achieved, which significantly enhances the flame-retardant effect.

For the production of the flame retardant coating according to the invention, the binder is introduced and mixed with the expandable graphite particles, the at least one chemical flame retardant and preferably a foam stabilizer to form a flame retardant paste. If desired or necessary, other additives are then added for improved manufacturability and suitability of the coating material, such as crosslinker, pigment and fluorocarbon. Subsequently, optional additives with additional functions (resistance to acids, alkalis, solvents, light stabilizers, radical scavengers, etc.) can be added while stirring.

The binders used in the process according to the invention are polyurethanes, polyacrylates or polyvinyl acetates, preferably polyurethanes with a molar mass of <700 g/mol, which are accessible by reacting polyvalent, aliphatic, cycloaliphatic and aromatic isocyanates known in polyurethane chemistry, such as hexane diisocyanate, the various isomers of tolylidenediisocyanate, diphenylmethane diisocyanate, with compounds having at least 2, in particular at least 3, reactive functional groups X—H (where X=N, O or S) and a molecular weight range of about 100 to 6000. Such compounds are higher molecular weight reactive compounds, such as polyesters, polyethers, polyacetals, polyamides and polyesteramides, but also low molecular weight polyols with in particular more than 2 OH groups, e.g. trimethylolpropane, 1,3,5-hexanetriol, glycerol and pentaerythritol or alkanolamines, e.g. triethanolamine; the polyurethanes obtained each have terminal hydroxyl, carboxyl or amino groups, but also NCO groups, the reaction of the higher molecular weight reactive compounds with the isocyanates optionally also being carried out in the presence of chain extenders, as is well known to those skilled in the art.

Generally, a dispersion of the binder or binder mixture, for example of a water-based polyurethane, is used to produce the flame retardant paste and/or the flame retardant coating. Iomeric polyurethanes are thus particularly suitable. The polyurethane dispersions preferably have a solids content of 30 to 70% by weight, in particular about 50% by weight. Preferably, various polyester polyols and polyether polyols, such as Pluriol®P 2000 (BASF) and Caradol® 36-3 (Shell), are suitable as polyol components. Flame retardant polyols containing, for example, phosphate or halogen groups can also be used as polyols. Suitable isocyanate components include, for example, 4,4′-diphenylmethane diisocyanate (MDI), isomers of tolylidenediisocyanate (TDI) or hexamethylene diisocyanate (HDI). In further embodiments, polyacrylate dispersions or other synthetic resin dispersions may also be used as binders. Polyurethane dispersions particularly preferred according to the invention include Dicrylan PGS (ERBA AG, Zurich, CH), Lamethane ADH-L (CHT) and Ruco-Coat EC 4811 (Rudolf-Chemie). A particularly preferred polyacrylate dispersion according to the invention is Dicrylan AS (ERBA AG, Zurich, CH).

The binder or binder mixture is preferably used in an amount of 20 to 70% by weight, preferably 30 to 50% by weight of the flame retardant paste and/or flame retardant coating.

The foam stabilizers used are generally a preparation of ammonium and alkylamine stearate and special surfactants, in particular Dicrylan Stabilizer 7805 (ERBA AG, Zurich, CH).

The foam stabilizer is preferably used in an amount of 10 to 40 wt. %, preferably 10 to 20 wt. % with respect to the total weight of the flame retardant paste and/or the flame retardant coating.

Furthermore, crosslinking agents and/or inorganic and/or organic dyes and pigments and/or other additives can be added to the flame retardant paste.

For example, in preferred embodiments, the flame retardant paste comprises a crosslinker. According to the invention, an aminoplast resin or a blocked isocyanate can preferably be used as the crosslinker. Suitable aminoplast resins or blocked isocyanates are, for example, the generally known commercially available products Knittex CHN (ERBA AG, Zurich, CH) or Phobol XAN (ERBA AG, Zurich, CH). Melamine-formaldehyde resins, in particular alkyl-modified melamine/formaldehyde derivatives, are preferred. The melamine/formaldehyde derivatives are usually used in powder form or preferably in the form of aqueous solutions having a solids content of 10 to 50% by weight, preferably 20 to 30% by weight. Preferred crosslinkers used according to the invention are Knittex CHN (ERBA AG, Zurich, CH).

The crosslinker is preferably used in an amount of 0 to 10 wt %, preferably 1 to 5 wt % with respect to the total weight of the flame retardant paste.

In further preferred embodiments, the flame retardant paste and/or the flame retardant coating may additionally contain pigments. The pigments used according to the invention may be inorganic or organic pigments.

Suitable pigments are, for example, white pigments or black pigments. White pigments used according to the invention are titanium dioxide, calcium carbonate, zinc carbonate, zinc oxide, silicates or silicic acid, alabaster brilliant white, kaolin or a similar material preferably titanium dioxide. White pigments are preferably used as an aqueous dispersion. Black pigments used according to the invention are all types of carbon black, such as gas carbon black, acetylene carbon black, thermal carbon black, furnace carbon black and flame carbon black, in particular flame carbon black. Black pigments are preferably used in the form of an aqueous dispersion with a solids content of 10 to 60%, preferably 20 to 40%.

Preferably, the pigment is used in an amount of 0.01 up to 10% by weight, more preferably in an amount of 0.1 up to 5% by weight with respect to the total weight of the flame retardant paste.

In further embodiments, thickeners may be added to the flame retardant paste and/or the flame retardant coating to adjust the viscosity. Suitable thickeners are conventional thickeners such as alginates, hydroxymethyl celluloses, polyacrylic acids, polyvinylpyrrolidones, silicates and layered silicates (e.g. betonites), kaolins, and the like. Thickeners used according to the invention are preferably alginates, hydroxymethyl celluloses or acrylic acid thickeners, in particular neutralized acrylic acid thickeners, wherein the viscosity being adjusted to a range of 10 to 30 dPa*s, preferably of about 20 dPa*s.

Preferably, the thickener is used in an amount of 0 up to 10% by weight, more preferably in an amount of 2 up to 6% by weight with respect to the total weight of the flame retardant paste and/or the flame retardant coating.

In further embodiments, the flame retardant paste and/or flame retardant coating contains a fluorocarbon to reduce moisture absorption and swelling tendency. The fluorocarbon may be a partially fluorinated or perfluorinated polymer. Both homopolymers and copolymers are suitable. Among others, fluoroalkyl acrylate homopolymers and fluoroalkyl acrylate copolymers are particularly suitable. Preferred fluorocarbons have perfluoroalkyl-containing side groups, which can be introduced into the fluoropolymer, for example, by polymerizing perfluoroalkyl-containing monomers.

Examples of commercially available fluorocarbons include, for example, Tubiguard, Evoral®, Oleophobol, Scotchguard, Repellan, Ruco-Guard, Unidyne, Quecophob and Nuva, and others.

Preferably, the fluorocarbon is used in an amount of 0.1 up to 10 wt % more preferably in an amount of 1 up to 5 wt % with respect to the total weight of the flame retardant paste and/or the flame retardant coating. In other embodiments, the flame retardant paste and/or the flame retardant coating may contain further additives, such as emulsifiers, light stabilizers, and/or further fillers such as chalk (to reduce costs).

Another aspect of the invention relates to a flame retardant textile sheet product comprising a textile carrier layer, wherein a plurality of coating elements or a continuous coating element is arranged on the textile carrier layer, wherein at least one coating element consists of or comprises the flame retardant coating according to the invention and described above. Preferably, such a flame retardant textile sheet product is used for protective clothing.

A flame-retardant textile sheet product according to the invention preferably comprises a plurality of layers, the first layer being a textile carrier layer. As a further layer, for example, a flame retardant coating according to the invention can be arranged, which is applied to the textile carrier layer.

In a preferred embodiment, the outer fabric may be partially (in certain patterns) or wholly colored with luminous colors to provide (according to EN ISO 20471) good visibility to the garment in a wide variety of environmental conditions. The use of such warning or signal colors necessarily finds application in many fields, such as police, firefighters, railroad employees, etc.

As a further layer, one or more water vapor permeable, breathable membranes can be arranged in a suitable position, preferably microporous PTFE or ePTFE, to impart breathability to the textile.

Furthermore, a textile sheet product according to the invention may comprise, in addition to a first outer textile carrier layer and a further layer with a flame retardant coating according to the invention, a second outer layer of knitted fabric. The second outer layer is typically disposed opposite the first outer layer. In the operative condition, the second outer layer faces the substrate and the first outer textile layer faces the environment. Such a second outer layer of knitted fabric has the advantage that, when exposed to flame, it exerts a high counterpressure with respect to the expandable graphite in the flame retardant coating of the invention, so that the expandable graphite expands selectively and efficiently in the direction of the flames. Preferably, the particle density of the expandable graphite particles is 10 to 500 particles/cm³, preferably 50 to 300 particles/cm³. Such a particle density has been found to be particularly advantageous, since the chemical flame retardants can be transported much more efficiently to the surface exposed to the flames. In addition, the increased particle density generally improves the flame retardant effect, since the intumescent layer is enlarged.

Another aspect of the invention relates to a method for producing a flame retardant textile sheet product comprising a textile backing layer. The method according to the invention comprises the steps:
a) Preparation of a flame retardant paste comprising at least one binder or binder mixture, expandable graphite particles and at least one chemical flame retardant, wherein the grain size of at least 80%, in particular at least 90%, 95%, preferably 100%, of the expandable graphite particles is at most 100 μm, in particular 75 μm, preferably 50 μm;
b) Optional foaming of the flame retardant paste to form an unstable or stable foam;
(c) Application of the flame retardant paste by stencil printing or application of the unstable or stable foam by foam coating to the textile backing layer; and
d) Drying, preferably at a temperature of 80 to 100° C.

Optionally, crosslinking of the binder or binder mixture can be carried out after or during step d). Preferably, the crosslinking is carried out at a temperature of about 120 to 180° C.

The expandable graphite in step a) may also have one or more properties described with respect to flame retardant coatings according to the invention. In step a), the at least one binder or binder mixture, the expandable graphite particles and the at least one chemical flame retardant can be mixed directly with one another, in particular by stirring.

The optional foaming in step b) is preferably continuous and usually mechanical. This can be done in a foam generator by injecting compressed air and beating between a rotor and a stator. Another possibility is to foam the flame retardant paste in a foam mixing unit by applying high shear forces. Preferably, a Hansa ECO-MIX (Hansamixer) is used. Foaming is carried out in such a way that the foam density obtained is between 80 and 300 g/l, preferably 80 to 200 g/l, particularly preferably 100 to 150 g/l, depending on the application for compressed foams. For stable foams, the preferred density is between 150 and 600 g/l, whereby it is known to the skilled person that the particularly preferred ranges result from the end application and cannot be given as a general rule.

In the case of foam coating, the application in step c) can be carried out by using a foam application system by means of a roller doctor blade, air knife, Variopress, preferably with a roller doctor blade. The foam is pumped in front of the coating doctor blade, where a coating takes place that can be regulated by the selected gap thickness in the overlay. The gap thicknesses can generally be in the range of about 0.5 to 3 mm, generally preferably 1 to 2 mm, although the skilled person can also deviate from this size depending on the application. In a further embodiment, several layers may be coated on top of each other for even higher coating thicknesses. The foam can generally be applied to a textile in a layer thickness of 1 to 5 mm, preferably 1.5 to 3 mm. The amount of foam coating to be applied varies depending on the desired property of the textile sheet product according to the invention, and is about 20 to 400 g/m², it being known to the skilled person that the preferred range is again derived from the field of application and cannot be given as a general rule.

In step d), drying can preferably take place in a stenter frame. The low temperature of 80 to 100° C. serves to avoid crosslinking of the binder. At the outlet of the stenter frame, the dried foam can be compressed by two rollers, whereby the foam disintegrates and is compressed into a membrane-like layer. The subsequent condensation fixes the layer in this form. This process is generally suitable for all laminates for outerwear, pants and the like. The small grain size of the expandable graphite particles according to the invention, as well as the increased stability of the particles due to the height-to-width ratio according to the invention, means that the expandable graphite particles do not break during compression. In the case of stable foam coatings with higher densities, the flame retardant paste is continuously foamed and applied to the textile in the same way as for the unstable foam described above. The stable foams are also carefully dried at approx. 80 to 100° C., particularly in the stenter frame. As an additional increase in the stability of the foam, partial or complete crosslinking can be achieved, for example, by setting the rearmost stenter frame panels to a higher temperature of approx. 120 to 180° C. The foam is then dried carefully in the stenter frame. Full crosslinking can be achieved by an additional condensation step at a temperature of approx. 130 to 180° C. Stable foams are useful when, in addition to flame protection, haptic (for example, a foam handle), optical (for example, a neoprene-like appearance) or other requirements are placed on the textile. For example, stabilizing foams can be used to provide light impact protection or thermal insulation.

Typically, in step c), a woven, knitted or nonwoven textile carrier layer is coated in the process

In a preferred embodiment, in step c), the flame retardant coating is applied to the textile backing layer in an amount of 10 to 400 g/m².

In a further embodiment, the application in step c) is carried out with a layer thickness of 0.2 to 5 mm, preferably 0.5 to 2 mm.

Another aspect of the invention relates to the use of the above-mentioned flame-retardant textile sheet products according to the invention in the manufacture of protective clothing.

### EXAMPLES

The following example formulation for a flame retardant paste according to the invention is to be understood merely as representative embodiments and not as limiting the scope of the present invention. In addition to this formulation, various possible variations and modifications are apparent to those skilled in the art from the entire description, which also fall within the scope of the claims.

| Weight % | Component | Example |
|---|---|---|
| 35% | Binder: Aliphatic polyester urethane dispersion, 50% solids content, | Dicrylan PGS |
| | as well as aromatic or also polyether urethanes; alternatively, | |
| | polyacrylate dispersions or other synthetic resin dispersions. | |
| | Preferably as aqueous dispersions. | |
| 15% | Foam stabilizer: preparation of ammonium and alkyl amine stearate | Dicrylan stabilizer |
| | and special surfactants | 7805 |
| 1% | Pigment: Aqueous flame black dispersion | |
| 3% | Crosslinker: Alkyl-modified melamine/formaldehyde derivative in | Knittex CHN |
| | aqueous solution. Alternatively, dispersions of blocked or free | |
| | isocyanates. | |
| 30% | Expandable graphite: mean grain size < 75 μm. | BLG40 Remacon |
| 10% | Chemical flame retardant: polyammonium phosphate and melamine- | Textal FR-SB |
| | formaldehyde condensate | ERBA |

The above formulation is foamed to 140 g/l to form an unstable foam and applied to the textile at 1 mm gap height and 50 g/m² coating overlay.

According to EN ISO 15025, in particular EN ISO 15025:2016, method A (surface flame treatment), the general combination of expandable graphite with a grain size of less than 100 μm and a chemical flame retardant present in the flame retardant coating, such as according to the embodiment example shown above, does not cause burning dripping, hole-formation, afterburning, afterglowing, melt dripping or continuous burning.

1. A flame retardant coating for a textile sheet product, wherein the flame retardant coating comprises at least one binder or a binder mixture, expandable graphite particles and at least one chemical flame retardant, wherein the grain size of at least 80% of the expandable graphite particles is at most 100 μm.

2. The flame retardant coating according to claim 1, wherein the grain size of at least 80% of the expandable graphite particles is at most 75 μm.

3. The flame retardant coating according to claim 1, wherein the at least one binder or binder mixture has a melting point or softening point in the range of 120 to 200° C.

4. The flame retardant coating according to claim 1, wherein the expandable graphite particles expand substantially only above a temperature of 200° C.

5. The flame retardant coating according to claim 1, wherein the at least one chemical flame retardant is selected from the group consisting of polyammonium phosphates, melamine cyanurates, aluminum hydroxide, magnesium hydroxide, antimony compounds, and combinations thereof.

6. The flame retardant coating according to claim 1, wherein the flame retardant comprises

| | |
|---|---|
| 20 to 40 wt. % | expandable graphite particles and/or |
| 5 to 15 wt. % | chemical flame retardant; and/or |
| 30 to 40 wt. % | binder or binder mixture. |

7. A flame retardant textile sheet product comprising a textile backing layer, wherein a plurality of coating elements or a continuous coating element is arranged on the textile backing layer, wherein at least one coating element consists of the flame retardant coating according to claim 1.

8. The flame retardant textile sheet product according to claim 7, wherein the particle density of the expandable graphite particles is 10 to 500 particles/cm³.

9. The flame retardant textile sheet product according to claim 7, wherein the textile backing layer forms a first outer layer and wherein the flame retardant textile sheet product comprises a second outer layer, the second outer layer being a knitted fabric.

10. A method for producing a flame retardant textile sheet product containing a textile backing layer comprising the steps of:
a) Preparation of a flame retardant paste comprising at least one binder or binder mixture, expandable graphite particles and at least one chemical flame retardant, wherein the grain size of at least 80% of the expandable graphite particles is at most 100 μm;
b) Optional foaming of the flame retardant paste to form an unstable or stable foam;
c) Application of the flame retardant paste by stencil printing or application of the unstable or stable foam by foam coating to the textile backing layer; and
d) Drying.

11. The method according to claim 10, wherein in step c) a woven, knitted or nonwoven textile backing layer is coated.

12. The method according to claim 10, wherein in step c) the flame retardant coating is applied to the textile backing layer in an amount of 20 to 400 g/m².

13. The method according to claim 10, wherein in step c) the flame retardant coating is applied with a layer thickness of 1 to 5 mm.

14. A flame retardant garment comprising at least one flame retardant textile sheet product according to claim 1.

15. The flame retardant coating according to claim 1, wherein grain size of 100% of the expandable graphite particles is at most 100 μm.

16. The flame retardant coating according to claim 1, wherein the grain size of at least 80% of the expandable graphite particles is at most 50 μm.

17. The flame retardant coating according to claim 1, wherein the at least one binder or binder mixture has a melting point or softening point in the range of 150 to 200° C.

18. The flame retardant textile sheet product according to claim 7, wherein the particle density of the expandable graphite particles is 50 to 300 particles/cm³.

19. The method for producing a flame retardant textile sheet product according to claim 10, wherein the grain size of 100% of the expandable graphite particles is at most 100 μm.

20. The method for producing a flame retardant textile sheet product according to claim 10, wherein the drying is conducted at a temperature of 80 to 100° C.

21. A flame retardant textile sheet product comprising a textile backing layer, wherein a plurality of coating elements or a continuous coating element is arranged on the textile backing layer, wherein at least one coating element comprises the flame retardant coating according to claim 1.
